(19) United States
(12) Patent Application Publication
(10) Pub. No.: US 2008/0147320 A1
(43) Pub. Date: Jun. 19, 2008

(54) AIRCRAFT AIRSPACE DISPLAY

(75) Inventor: Matthew C. Burch, Lawrence, KS (US)

Correspondence Address: GARMIN INTERNATIONAL, INC.;ATTN: Legal - IP, 1200 EAST 151ST STREET, OLATHE, KS, 66062, US

(73) Assignee: GARMIN INTERNATIONAL, INC., Olathe, KS (US)

(21) Appl. No.: 11/612,767

(22) Filed: Dec. 19, 2006

(51) Int. Cl. G01C 21/30; G01C 21/00; G01C 21/02

(52) U.S. Cl. 701/211; 701/207; 701/213

(57) ABSTRACT

A navigation device displays representations of airspaces so that a viewer such as the pilot of the aircraft can more easily distinguish between the airspaces represented based on a status of the aircraft. The navigation device includes a display assembly for displaying information to a user such as the pilot of an aircraft. A processing system is coupled to the display assembly and is configured for causing the display assembly to display a plurality of airspace representations. The processing system varies the emphasis of at least one airspace representation relative to a second airspace representation based on a status of the aircraft so that viewer may pay special attention to airspace representations which are displayed with relatively greater emphasis.

### BACKGROUND

1. FIELD

The present invention relates to navigation devices for use in aircraft, and more particularly, to a navigation device and a related method for more effectively displaying representations of an airspace, such as a restricted airspace, a controlled airspace, a prohibited airspace, a special-use airspace, or the like, based on a status of the aircraft.

2. Description of the Related Art

Pilots of aircraft must learn and adhere to flight rules and interpret and respond to an ever-increasing amount of data and communication information while flying. In particular, pilots must know when they are in, or about to enter, an airspace, such as a restricted airspace, a controlled airspace, a prohibited airspace, a special-use airspace, or the like. Moreover, they must learn and know the rules for flying within such an airspace. Airspace distinctions and the rules associated therewith can be complex and may on occasion require a great deal of a pilot's time and attention while flying.

To assist pilots in identifying airspaces and adhering to airspace rules, many aircraft are equipped with an avionic system which displays a moving map that includes a depiction of the aircraft's position relative to nearby airspaces. Information about each airspace, such as the class and altitude ranges of the airspace may also be displayed as text overlaid onto the moving map. However, while such avionic systems assist pilots in identifying nearby airspaces, a significant amount of textual data must be displayed over the map to provide the pilot with required information about each of the airspaces shown. This information can cause the display to become cluttered when multiple airspaces are displayed. Further, all airspaces are typically shown on the moving map, and the pilot must rely on the textual information to distinguish those airspaces that are relevant to the aircraft's position and altitude.

Accordingly, it would be desirable to provide a navigation device and related method for more effectively displaying representations of airspaces to the pilot of the aircraft so that the pilot can more easily distinguish between the airspaces based on the position and altitude of the aircraft.

### SUMMARY

The present invention is directed to a navigation device and related method for displaying representations of airspaces, such as restricted airspaces, controlled airspaces, prohibited airspaces, special-use airspaces, or the like, so that a viewer can more easily distinguish between the airspaces represented based on a status of the aircraft.

In one specific embodiment, the navigation device includes a display assembly for displaying information to a user such as the pilot of an aircraft. A processing system is coupled to the display assembly and is configured for causing the display assembly to display a plurality of airspace representations. For example, in embodiments of the invention, the airspace representations may be displayed over a moving map displayed by the display assembly. The processing system varies the emphasis of at least one airspace representation relative to a second airspace representation based on a status of the aircraft so that the viewer (e.g., the pilot of the aircraft) may pay special attention to airspace representations which are displayed with relatively greater emphasis. For example, the processing system may determine that a nearby airspace does not encompass the current altitude of the aircraft. The processing system therefore de-emphasizes the representation of this airspace on the display so that the pilot can quickly and easily ascertain that the airspace is not of immediate relevance. This permits the pilot to focus his attention on the airspace having displayed representations which have not been de-emphasized.

In exemplary embodiments, the processing system may de-emphasize the display of certain airspace representations by reducing the line thickness of the airspace representations, by depicting the airspace representations with broken lines, by changing the color of the airspace representations, or by any other method which de-accentuates some of the airspace representations relative to others. Alternatively, rather than de-emphasizing selected airspace representations, the processing system may instead emphasize certain airspace representations which are currently more relevant by increasing the line thicknesses, changing the color, or otherwise accentuating the airspace representations.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Embodiments of the present invention are described in detail below with reference to the attached drawing figures, wherein:

FIG. 1 is a perspective view of an exemplary navigation device which may be used to implement certain aspects of the present invention.

FIG. 2 is a block diagram of selected components of the navigation device.

FIG. 3 is schematic diagram of the Global Positioning Satellite (GPS) system.

FIG. 4 is a flow diagram illustrating selected steps in a method of the present invention.

FIG. 5 is a representation of a moving map shown on the navigation device display.

FIG. 6 is another representation of a moving map shown on the navigation device display.

FIG. 7 is another representation of a moving map shown on the navigation device display.

FIG. 8 is another representation of a moving map shown on the navigation device display.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

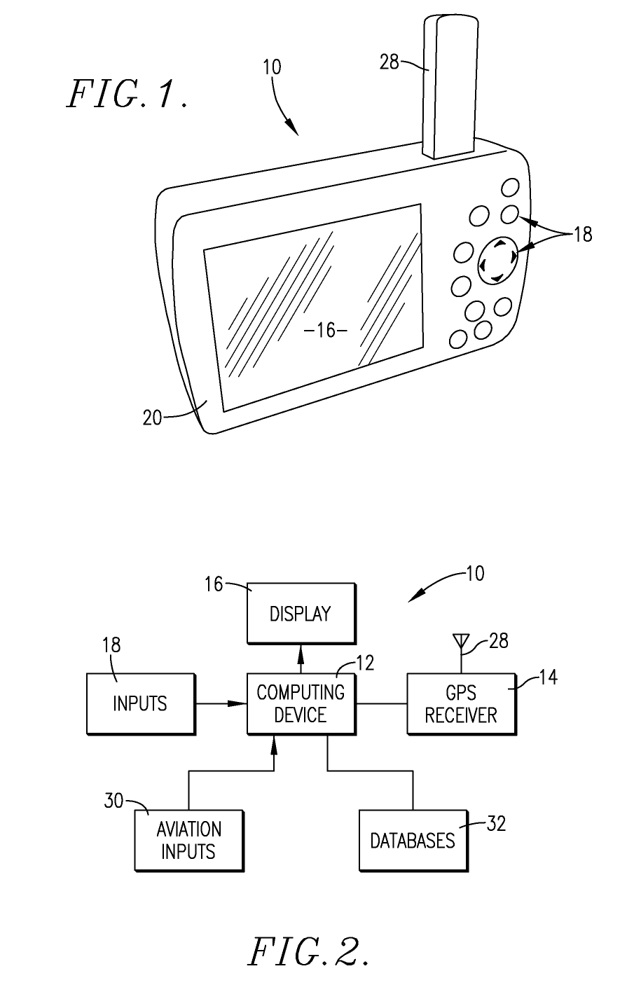

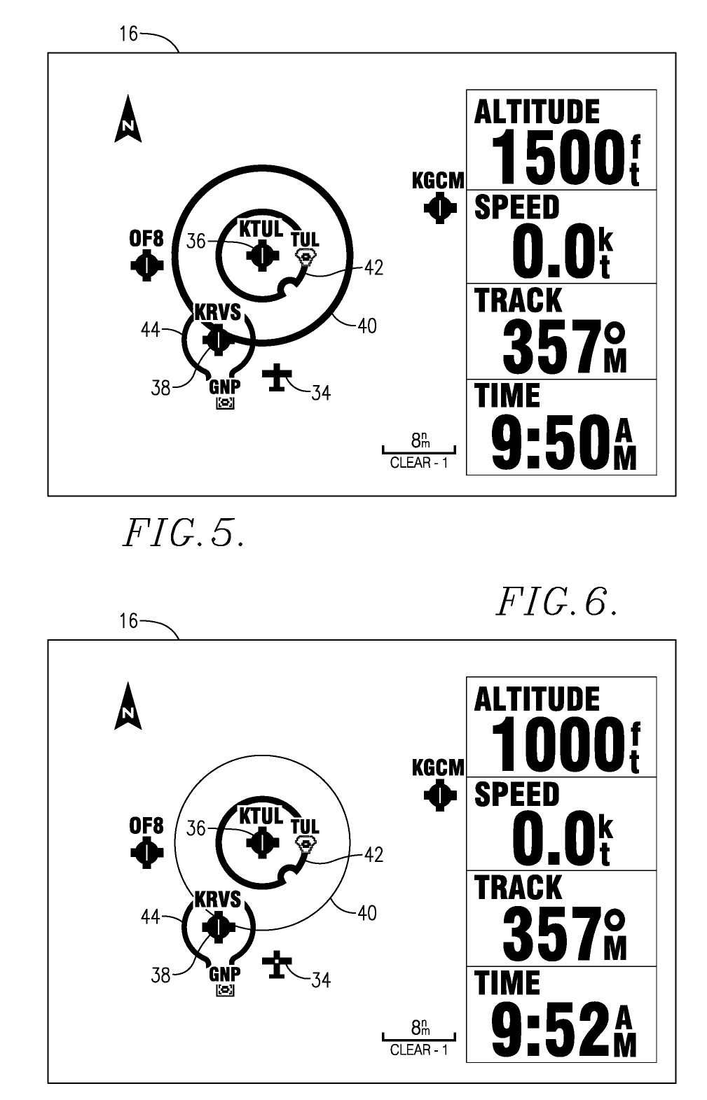

Referring initially to FIGS. 1 and 2, a navigation device 10 in accordance with an exemplary embodiment of the present invention is described. In the embodiment illustrated, the navigation device 10 comprises a processing system 12; a location determining system 14; a display assembly 16; one or more input devices 18; and a housing 20 which encloses and protects the other components from moisture, vibration, impact, electromagnetic interference, and the like. In accordance with the present invention, the processing system is coupled to the display assembly 16 and is configured for causing the display assembly 16 to display a plurality of airspace representations (see FIGS. 5 through 8). The processing system 12 varies the emphasis of at least one airspace representation relative to a second airspace representation based on a status of the aircraft so that the pilot of the aircraft may pay special attention to all airspace representations which are displayed with relative greater emphasis.

The processing system 12 may include any number of computing devices such as processors, controllers, or other processing devices and resident or external memory for storing data and other information accessed and/or generated by the navigation device 10. In accordance with one aspect of the invention, the processing system 12 implements a computer program which controls the display of information on the display assembly 16 as described herein. The computer program preferably comprises an ordered listing of executable instructions for implementing logical functions in the processing system. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

As shown in FIG. 2, the location determining system 14 may comprise a global positioning system (GPS) receiver. For example, the location determining system 14 may be, for example, be a GPS receiver much like those provided in products by Garmin Corporation and disclosed in U.S. Pat. No. 6,434,485, which is incorporated herein by specific reference. In specific embodiments of the invention, the GPS receiver may comprise a WAAS (Wide Area Augmentation System) enabled, twelve parallel channel GPS receiver, which provides, in a substantially conventional manner, geographic location information for the navigation device 10.

In general, the Global Positioning System is a satellite-based radio navigation system capable of determining continuous position, velocity, time, and direction information for an unlimited number of users. Formally known as NAVSTAR, the GPS incorporates a plurality of satellites which orbit the earth in extremely precise orbits. Based on these precise orbits, GPS satellites can relay their location to any number of receiving units.

The GPS system is implemented when a device specially equipped to receive GPS data begins scanning radio frequencies for GPS satellite signals. Upon receiving a radio signal from a GPS satellite, the device can determine the precise location of that satellite via one of different conventional methods. The device will continue scanning for signals until it has acquired at least three different satellite signals. Implementing geometrical triangulation, the receiver utilizes the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS enabled devices are often used to describe navigational devices, it will be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. In this way, personal hand held devices, cell phones, intelligent appliances, intelligent apparel, and others can be readily located geographically, if appropriately equipped to be a receiving unit.

FIG. 3 shows one representative view of a GPS denoted generally by reference numeral 22. A plurality of satellites 24 are in orbit about the Earth 26. The orbit of each satellite is not necessarily synchronous with the orbits of other satellites and, in fact, is likely asynchronous. A GPS receiver equipped navigation device 10 such as the ones described in connection with preferred embodiments of the present invention is shown receiving spread spectrum GPS satellite signals from the various satellites 24.

The spread spectrum signals continuously transmitted from each satellite 28 utilize a highly accurate frequency standard accomplished with an extremely accurate atomic clock. Each satellite 24, as part of its data signal transmission, transmits a data stream indicative of that particular satellite. The navigation device 10 must acquire spread spectrum GPS satellite signals from at least three satellites for the GPS receiver device to calculate its two-dimensional position by triangulation. Acquisition of an additional signal, resulting in signals from a total of four satellites, permits the navigation device 10 to calculate its three-dimensional position and altitude.

The location determining system 14 is operable to receive navigational signals from the GPS satellites 24 to calculate a position and altitude of the navigation device 10 as a function of the signals. The location determining system 14 is also operable to calculate a route to a desired location, provide instructions to navigate to the desired location, display maps and other information on the display assembly 16, and to execute other functions described herein.

The location determining system 14 may include one or more processors, controllers, or other processing systems and memory or may utilize the components of the processing system 12. The memory of the processing system 12 and/or the location determining system 14 may store cartographic data and routing used by or generated by the location determining system. The memory may be integral with the location determining system 14, integral with the processing system 12, stand-alone memory, or a combination of both. The memory may include, for example, removable data cards such as TransFlash cards, manufacturer proprietary data cards, or the like.

The location determining system 14 also includes an antenna 28 to assist the location determining system in receiving signals. The antenna is preferably a removable quad-helix antenna but may be any other type of antenna that can be used with navigational devices. The antenna may be mounted directly on or in the housing as shown in FIG. 1 or may be mounted external to the housing.

The navigation device 10 may also include an integrated GXM 30A Smart Antenna or other similar antenna that receives signals for NEXRAD radar imaging, over 170 channels of XM Satellite Radio, traffic information, weather information, and general navigation and aviation related information.

The display assembly 16 is coupled with the processing system 12 and the location determining system 14 for displaying data and information as described herein. The display assembly 16 is preferably an LCD display capable of displaying both text and graphical information. The display may also be backlit such that it may be viewed in the dark or other low-light environments. One example of a display that may be used with the present invention is a 320×480 pixel display with adjustable backlighting.

As illustrated in FIG. 1, the display assembly 16 is preferably positioned on a front face of the housing for easy viewing. The inputs 18 may be positioned on the front of the housing 20 such that they may be easily accessed. The inputs 18 may include descriptive markings that identify their function. The inputs may be buttons, switches, keys, an electronic touchscreen associated with the display, voice recognition circuitry, or any other elements capable of controlling the processing system and location determining system.

The navigation device 10 may also include a speaker for providing audible instructions and feedback, a microphone for receiving voice commands, an infrared port for wirelessly receiving and transmitting data and other information from and to nearby electronics, and other information, and even a cellular or other radio transceiver for wirelessly receiving and transmitting data from and to remote devices. For example, the radio transceiver may permit the navigation device 10 to communicate with a remote server.

The navigation device 10 may also include a number of I/O ports that permit data and other information to be transferred to and from the processing system 12 and the location determining system 14. The I/O ports may include a data card slot for receiving removable data cards such as manufacturer proprietary data cards, TransFlash cards, or the like, and a USB port for coupling with a USB cable connected to another processing system such as a personal computer. Navigational software, cartographic maps and other data and information may be loaded in the navigation device 10 via the I/O ports, the wireless transceivers, or the infrared port mentioned above.

The navigation device 10 may also include inputs 30 which may be directly or indirectly coupled with sensors or other devices which sense the state of certain aspects of the aircraft. For example, the navigation device 10 may receive inputs from an aircraft-mounted barometric altimeter which determines an altitude of the aircraft. Alternatively, the navigation device may include its own internal barometric altimeter which senses altitude independently of the GPS receiver 14. The sensors may also indicate a heading of the aircraft, a speed of the aircraft, a flight plan for the aircraft, fuel level, a wind speed experienced by the aircraft, a wind direction experienced by the aircraft, a temperature experienced by the aircraft, and a weather condition currently experienced or to be experienced by the aircraft.

The device may also have access to one or more databases broadly referred to by the numeral 32. The databases may include, for example, information about all known controlled, special use, and prohibited airspace including the locations of the airspace and the altitude and radius ranges for the airspace. The databases may also include Garmin SafeTaxi™ data (SafeTaxi is a trademark of Garmin International, Inc.), including detailed airport and taxiway drawings for every United States airport. The databases may also include the ATIS, clearance, ground and tower frequencies for all known airports; stored waypoints and other navigation information; pre-flight, pre-landing, and pre-taxi checklists and other checklists; stored flight plans; general information about the aircraft and airports used by the aircraft; topographic data; obstacle locations and heights; terrain elevation data; airplane configuration settings; pilot profiles; arrival procedures; departure procedures; approach procedures; airport diagrams; runway and taxiway data; weather frequencies; user defined waypoints; VORs; NDBs; and intersections, airways, and airspace boundaries.

The housing 20 is constructed from a suitable lightweight and impact-resistant material such as, for example, plastic, nylon, aluminum, or any combination thereof. The housing 20 may include one or more appropriate gaskets or seals to make it substantially waterproof or resistant. The housing 20 may include a location for a rechargeable battery or other power source. The housing 20 may take any suitable shape or size, and the particular size, weight and configuration of the housing may be changed without departing from the scope of the present invention. The housing 20 may also include or be coupled to mounting hardware for securing the navigation device 10 to a surface within an aircraft. Alternatively, the housing 20 may be configured to be panel-mounted or rack-mounted within the aircraft.

The components shown in FIG. 2 and described herein need not be physically connected to one another since wireless communication among the various depicted components is permissible and intended to fall within the scope of the present invention.

The navigation device 10 described herein may be used by a pilot to navigate an aircraft in a conventional manner and to display a number of airspace representations superimposed on a moving map. In accordance with one important aspect of the present invention, the processing system 12 is configured for controlling the display assembly 16 to cause the display assembly 16 to vary the emphasis of at least one airspace representation relative to a second airspace representation based on a status of the aircraft so that the pilot of the aircraft may pay special attention to all airspace representations which are displayed with relative greater emphasis.

Each of the plurality of airspace representations displayed by the display assembly 16 designates an airspace having an associated altitude range. In exemplary embodiments, the display assembly 16 emphasis of the airspace representations is selected based on whether the current altitude of the aircraft, as sensed by the GPS receiver 12 or an internal or external barometric altimeter, is within or close to the altitude ranges of nearby airspace. For example, if the processing system 12 determines that a nearby airspace does not encompass the current altitude of the aircraft, it de-emphasizes the representation of this airspace on the display assembly 16 so that the pilot can quickly and easily ascertain that the airspace is not of immediate importance.

The processing system 12 may add a safety or error margin to the airspace altitude ranges so that an airspace representation is not de-emphasized if the current altitude of the aircraft is close to, but not within, one of the altitude boundaries of the airspace. For example, the processing system 12 may continue to display an airspace representation in a “normal” fashion (not de-emphasized) if the current altitude of the aircraft is within 1,000 feet of either altitude boundary of the airspace.

One way to provide the safety or error margin is to simply add a “buffer” altitude value to all airspace altitude ranges. For example, a class C airspace with an altitude range of 2,300 feet MSL to 4,700 feet MSL would have a buffered altitude range of 1,300 feet MSL to 5,700 feet MSL if the buffer value is 1,000 feet.

The buffer may also be variable to provide a greater safety margin at higher altitudes where altitude measurements may not be as accurate. For example, the processing system 12 may add a buffer that starts at 1,000 feet and increases linearly as the current altitude of the aircraft increases between ground level and 10,000 feet MSL and that is fixed at 2,000 feet when the current altitude of the aircraft is above 10,000 feet MSL. The buffer for this embodiment would therefore be 1,000 feet for ground level, 1,500 feet for an aircraft altitude of 5,000 feet, and 2,000 feet for all aircraft altitudes above 10,000 feet. The buffer value can of course be calculated in different manners without departing from the scope of the invention.

The processing system 12 may de-emphasize the display of the airspace representations by reducing the line thickness of the airspace representations, depicting the airspace representations with broken lines, changing the color of the airspace representations, or by any other method which de-accentuates some of the airspace representations relative to others. Rather than de-emphasizing selected airspace representations, the processing system may instead emphasize airspace representations which are currently more relevant by increasing the line thicknesses, changing the color, or otherwise accentuating the airspace representations.

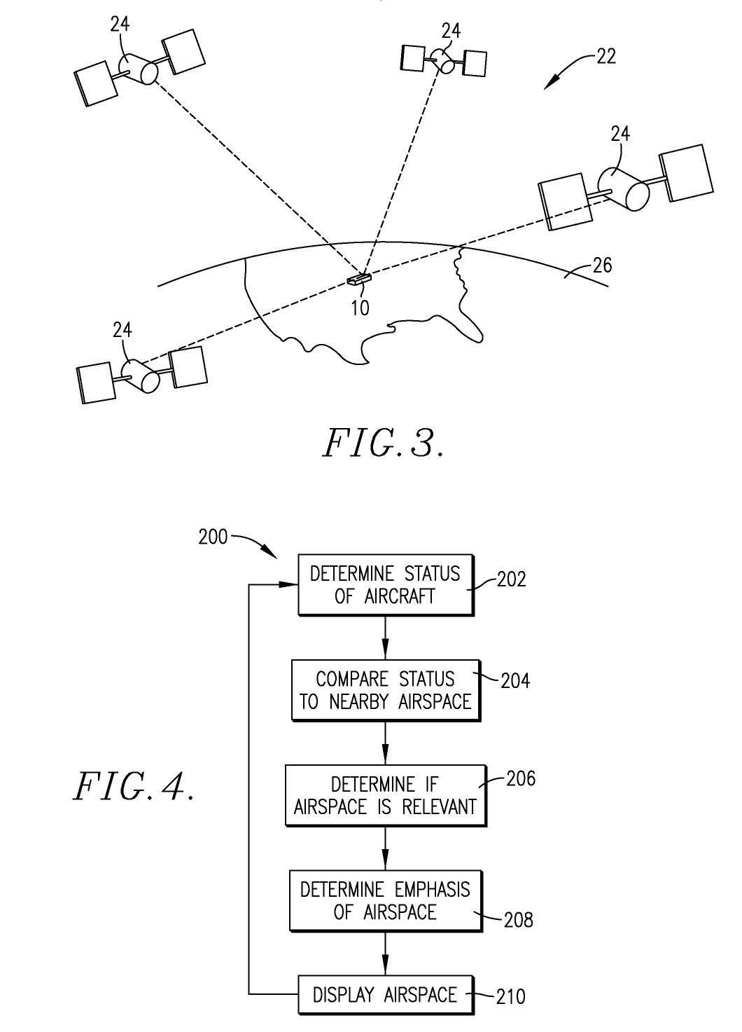

FIG. 4 illustrates certain steps in an exemplary method 200 of using the navigation device 10. The particular order of the steps illustrated in FIG. 4 and described herein can be altered without departing from the scope of the invention. For example, some of the illustrated steps may be reversed, combined, or even removed entirely.

In step 202, a status of an aircraft is first determined. The status may be, for example, an altitude or position of the aircraft. If the status is the altitude of the aircraft, it may be sensed by the GPS receiver 12 or an internal or external barometric altimeter.

The status of the aircraft is then compared to nearby airspace or other objects in step 204. For example, the altitude of the aircraft may be compared to the altitude ranges for all airspace which is within a selected distance of the aircraft. A safety or error margin may be added to all airspace altitude ranges as discussed above.

A determination is then made, in step 206, whether any of the nearby airspace or other objects are relevant based on the comparison in step 204. For example, all airspace having altitude boundaries which encompass the current altitude of the aircraft may be considered relevant. As with step 204, a safety or error margin may be added to all airspace altitude ranges when determining whether they are relevant.

In step 208, the emphasis level for representing the airspace on a display in the aircraft is determined. For example, the representations of all airspace which are considered to be relevant in step 206 may be emphasized and/or the representations of the airspace which are not considered to be relevant may be de-emphasized.

In step 210, both the emphasized and the de-emphasized airspace representations for airspaces which are within a selected distance of the aircraft are displayed. The method 200 then returns to step 202 to again determine the status of the aircraft and perform the other steps of the method to update the display based on a movement of the aircraft or other status change.

FIGS. 5 through 8 illustrate exemplary moving maps that may be displayed by the navigation device 10 using the method 200. In these illustrations, much of the traditional moving map data, such as depictions of terrain, landmarks, streets, and other information has been turned off so that the airport data and airspace representations are easier to identify. In all of the illustrations, an airplane 34 is shown near Tulsa, Okla. Based on the scale and zoom of the display assembly 16 shown in the illustrations, the visible airports which have airspace are Tulsa International (KTUL) 36 and Jones Riverside Airport (KRVS) 38.

FIG. 5 illustrates the aircraft 34 at 1,500 feet MSL (above sea level), which is about 900 feet AGL (above ground level). KTUL 36 includes two rings of airspace: an outer ring of class C airspace 40 which goes from 2,300 feet MSL up to 4,700 feet MSL; and an inner ring of class C airspace 42 which goes from the surface to 4,700 feet MSL. KRVS 38 has a single ring of class D airspace 44 which goes from the surface to 3,100 feet MSL. In FIG. 4, the feature of the navigation device which accentuates or de-accentuates selected airspace representations is turned off so that all three of the airspace representations 40, 42, 44 are shown in a normal fashion.

In FIGS. 6 through 8, the accentuating/de-accentuating functions of the navigation device 10 are enabled. FIG. 5 illustrates the aircraft 34 at 1,000 feet MSL. Because the aircraft 34 is now well below the outer ring of KTUL=s class C airspace 40, which has an altitude range of 2,300-4,700 feet, the airspace representation 40 is de-emphasized. However, the aircraft 34 is still within the inner ring of KTUL=s class C airspace 42, which has an altitude range of 0-4,700 feet, and KRVS=s class D airspace 44, which has an altitude range of 0-3,100 feet, so the airspace representations 42, 44 are not de-emphasized. This tells the pilot of the aircraft 34 that he presently needs to pay more attention to airspaces 42, 44 than airspace 40.

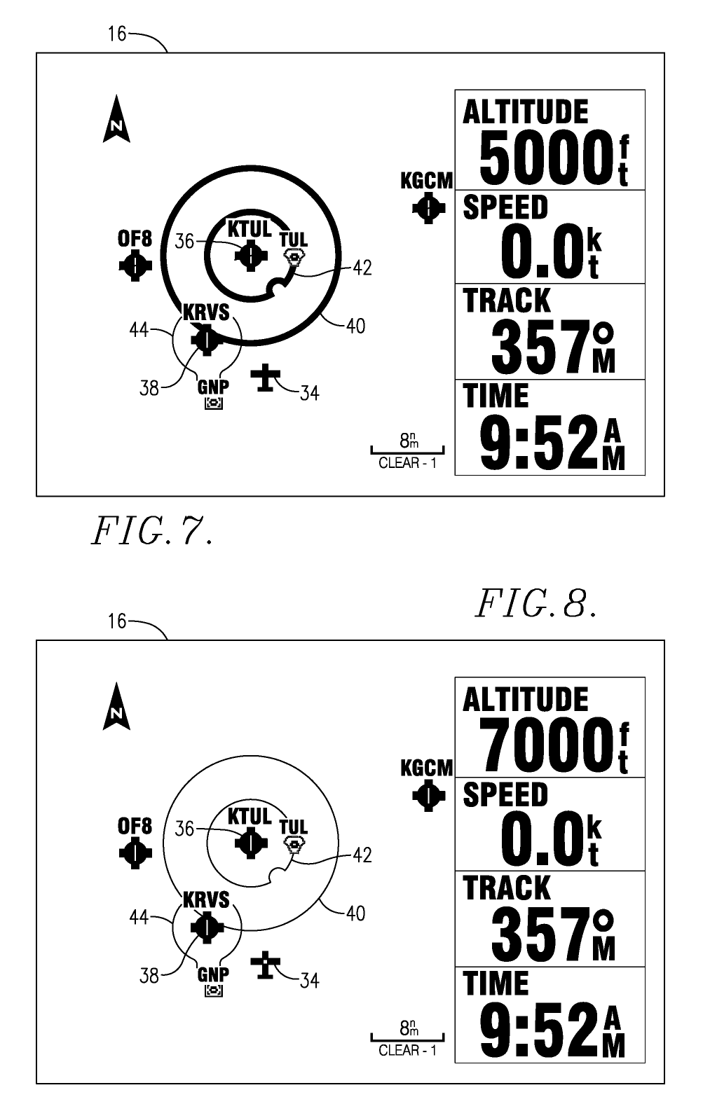

FIG. 7 illustrates the aircraft 34 at an altitude of 5,000 feet MSL. Because the aircraft is well above KRVS=s airspace 44, this airspace representation 44 is de-emphasized. However, the aircraft is still within the buffered altitude ranges of both rings of KTUL=s airspace (assuming a buffer value of 1,000 feet), so these airspace representations 40, 42 are not de-emphasized.

FIG. 8 illustrates the aircraft at 7,000 feet MSL. Because the aircraft 34 is well above the buffered altitude ranges of all three illustrated airspaces 40, 42, 44, all three of the airspace representations are de-emphasized.

The present invention can be implemented in hardware, software, firmware, or a combination thereof. In one embodiment, however, the invention is implemented with a portable navigation device 10 illustrated in FIG. 1 such as the GPSMAP 496 provided by Garmin International, Inc. Alternatively, the invention may be implemented with a panel-mounted avionics system such as the G1000 integrated avionics system also provided by Garmin International, Inc. Certain components of an exemplary navigation device are broadly referred to by the numeral 10 in the drawing figures. The navigation device 10 and its components illustrated and described herein are merely examples of a device and components that may be used to implement the embodiments of the present invention and may be replaced with other devices and components without departing from the scope of the invention.

Although the invention has been described with reference to the exemplary embodiments illustrated in the attached drawing figures, it is noted that equivalents may be employed and substitutions made herein without departing from the scope of the invention as recited in the claims. For example, although FIGS. 4 through 7 show less relevant airspace representations as being de-emphasized on the display assembly 16, the device 10 may instead emphasize the more relevant airspace representations to provide the desired distinction on the display. The device of the present invention may also emphasize or de-emphasize other displayed objects such as terrain, towers, airports, and other possible obstructions and landmarks based on the current altitude of the aircraft or some other state of the aircraft. The device may also alter the emphasis of displayed objects based on other states of the aircraft such as the distance between the aircraft and the objects, the speed of the aircraft, the direction of the aircraft, and the like.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A navigation device for use in an aircraft, comprising:
a display assembly for displaying information; and
a processing system coupled to the display assembly, the processing system configured for causing the display assembly to display a plurality of airspace representations,
wherein the processing system varies the emphasis of a first airspace representation relative to a second airspace representation based on a status of the aircraft.

2. The navigation device as claimed in claim 1, wherein the status of the aircraft comprises a current altitude of the aircraft.

3. The navigation device as claimed in claim 2, further comprising a GPS receiver for determining the current altitude of the aircraft.

4. The navigation device as claimed in claim 2, wherein each of the plurality of airspace representations designates an airspace having an associated altitude range, and wherein the first airspace representation is de-emphasized because the associated altitude range of the airspace designated by the first airspace representation does not encompass the current altitude of the aircraft

5. The navigation device as claimed in claim 2, wherein each of the plurality of airspace representations designates an airspace having an associated altitude range and wherein the processing system adds a selected buffer to the altitude range of the airspace designated by the airspace representation to create buffered altitude range.

6. The navigation device as claimed in claim 5, wherein the first airspace representation is de-emphasized because the associated buffered altitude range of the airspace designated by the first airspace representation does not encompass the current altitude of the aircraft.

7. The navigation device as claimed in claim 5, wherein the processing system selects the buffer based on the current altitude of the aircraft.

8. The navigation device as claimed in claim 7, wherein the processing system increases the buffer as the current altitude of the aircraft increases.

9. The navigation device as claimed in claim 1, wherein the status of the aircraft comprises a current position of the aircraft.

10. The navigation device as claimed in claim 1, wherein the processing system de-emphasizes the first airspace representation relative to the second airspace representation.

11. The navigation device as claimed in claim 10, wherein the first airspace representation and the second airspace representation are depicted in lines having a line thickness, and wherein the first airspace representation is de-emphasized by reducing the line thickness of the first airspace representation relative to the line thickness of the second airspace representation.

12. The navigation device as claimed in claim 10, wherein the first airspace representation is de-emphasized by depicting the first airspace representation with broken lines.

13. The navigation device as claimed in claim 10, wherein the first airspace representation and the second airspace representation are depicted in color, and wherein the first airspace representation is de-emphasized by changing the color of the airspace representation so that the first airspace representation is a different color than the second airspace representation.

14. The navigation device as claimed in claim 1, further including a barometric altimeter for sensing a current altitude of the aircraft.

15. The navigation device as claimed in claim 1, further including an input port for receiving altitude data from an external barometric altimeter.

16. The navigation device as claimed in claim 1, wherein each of the plurality of airspace representations is displayed on a moving map.

17. A navigation device for use in an aircraft, comprising:
a display assembly for displaying information;
a GPS receiver for receiving satellite signals from a plurality of GPS satellites and for determining a current location and a current altitude of the aircraft based on the satellite signals; and
a processing system coupled with the display and the GPS receiver, the processing system configured for causing the display to display airspace representations for a plurality of airspaces each having an altitude range,
wherein the processing system causes the airspace representations of airspaces having altitude ranges which do not encompass the current altitude of the aircraft plus or minus a buffer value to be de-emphasized.

18. The navigation device as claimed in claim 17, wherein the airspace representations are depicted in lines having a line thickness, and wherein the airspace representations are de-emphasized by reducing the line thickness of the airspace representations.

19. The navigation device as claimed in claim 17, wherein the airspace representations are de-emphasized by depicting the airspace representations with broken lines.

20. The navigation device as claimed in claim 17, wherein the airspace representations are de-emphasized by changing a color of the airspace representations.

21. The navigation device as claimed in claim 17, wherein the processing system varies the buffer based on the current altitude of the aircraft.

22. The navigation device as claimed in claim 17, wherein the processing system increases the buffer as the current altitude of the aircraft increases.

23. The navigation device as claimed in claim 17, further comprising a barometric altimeter for sensing the current altitude of the aircraft.

24. The navigation device as claimed in claim 17, further comprising an input port for receiving altitude data from an external altimeter.

25. A method of displaying airspace representations on a display assembly in an aircraft, comprising:
determining a status of the aircraft;
causing the display assembly to display a plurality of airspace representations; and
varying the emphasis of a first airspace representation relative to a second airspace representation based on the determined status of the aircraft.

26. The method as claimed in claim 25, wherein the status of the aircraft comprises a current altitude of the aircraft.

27. The method as claimed in claim 26, wherein each of the plurality of airspace representations designates an airspace having an associated altitude range, and wherein the first airspace representation is de-emphasized because the associated altitude range of the airspace designated by the first airspace representation does not encompass the current altitude of the aircraft

28. The method as claimed in claim 26, wherein each of the plurality of airspace representations designates an airspace having an associated altitude range, and wherein a selected buffer is added to the altitude range of the airspace designated by the airspace representation to create buffered altitude range.

29. The navigation device as claimed in claim 5, wherein the first airspace representation is de-emphasized because the associated buffered altitude range of the airspace designated by the first airspace representation does not encompass the current altitude of the aircraft.

30. The method as claimed in claim 29, wherein the buffer is selected based on the current altitude of the aircraft.

31. The method as claimed in claim 30, wherein the buffer is increased as the current altitude of the aircraft increases.

32. The method as claimed in claim 25, wherein the status of the aircraft comprises a current position of the aircraft.

33. The method as claimed in claim 25, wherein the step of varying the emphasis of a first airspace representation relative to a second airspace representation comprises de-emphasizes the first airspace representation relative to the second airspace representation.

34. The method as claimed in claim 33, wherein the first airspace representation and the second airspace representation are depicted in lines having a line thickness, and wherein the first airspace representation is de-emphasized by reducing the line thickness of the first airspace representation relative to the line thickness of the second airspace representation.

35. The method as claimed in claim 33, wherein the first airspace representation is de-emphasized by depicting the first airspace representation with broken lines.

36. The method as claimed in claim 33, wherein the first airspace representation and the second airspace representation are depicted in color, and wherein the first airspace representation is de-emphasized by changing the color of the airspace representation so that the first airspace representation is a different color than the second airspace representation.

37. The method as claimed in claim 25, wherein each of the plurality of airspace representations is displayed on a moving map.

38. A navigation device for use in an aircraft, comprising:
means for displaying information; and
means coupled to the display means for causing the display means to display a plurality of airspace representations,
wherein the emphasis of a first airspace representation is varied relative to a second airspace representation based on a status of the aircraft.
